(19) United States
(12) Patent Application Publication
(10) Pub. No.: US 2010/0259404 A1
(43) Pub. Date: Oct. 14, 2010

(54) SYSTEM AND METHOD FOR DIAGNOSING HOME APPLIANCE

(76) Inventors: In Haeng Cho, Changwon-si (KR); Phal Jin Lee, Changwon-si (KR); Hoi Jin Jeong, Changwon-si (KR); Jong Hye Han, Changwon-si (KR)

Correspondence Address: KED & ASSOCIATES, LLP, P.O. Box 221200, Chantilly, VA, 20153-1200, US

(21) Appl. No.: 12/757,246

(22) Filed: Apr. 9, 2010

Related U.S. Application Data
(60) Provisional application No. 61/168,380, filed on Apr. 10, 2009.

(30) Foreign Application Priority Data
Apr. 10, 2009 (KR) 10-2009-0031498

(51) Int. Cl. G08B 21/00

(52) U.S. Cl. 340/679

(57) ABSTRACT

A system and method for diagnosing a home appliance are disclosed. The home appliance outputs product information as a sound signal, and transmits the sound signal over a communication network, such that a service center of a remote site easily checks a status of the home appliance. The home appliance outputs the sound signal including a large amount of product information, and the diagnostic server of the service center diagnoses a status of the home appliance using a large amount of product information contained in the sound signal, such that it recognizes a detailed cause of a fault of the home appliance and greatly increases the diagnosis accuracy.

### CROSS-REFERENCE TO RELATED APPLICATION

This application claims the benefit of U.S. Patent Application No. 61/168,380 filed on Apr. 10, 2009 in the USPTO, and Korean Patent Application No. 10-2009-0031498, filed on Apr. 10, 2009 in the Korean Intellectual Property Office, the disclosure of which is incorporated herein by reference.

### BACKGROUND OF THE INVENTION

1. Field of the Invention

The present invention relates to a system and method for diagnosing a home appliance, and more particularly to a system and method for diagnosing a home appliance, which check a current status of the home appliance by analyzing product information that is output as a predetermined sound signal from the home appliance, such that after-sale service for the home appliance is facilitated.

2. Description of the Related Art

While a home appliance carries out a specific operation, it stores setup values required for the specific operation, information generated by the operation, malfunction or faulty operation information, etc. Specifically, the home appliance outputs a predetermined alarm sound signal when a malfunction or faulty operation occurs, such that a user who uses the home appliance can easily recognize a status of the home appliance. The home appliance informs the user of the operation completion or the malfunction occurrence, and at the same time outputs detailed malfunction information through an output unit (e.g., a display unit or a lamp).

In the meantime, if a malfunction or faulty operation occurs in the home appliance, the user informs an after-sale service center of the occurrence of malfunction or faulty operation by phone or E-mail, such that the user may ask advice of a service technician or ask the service technician to repair the faulty home appliance.

Generally, malfunction or fault information may be output externally through the home appliance, or may also be output as a fault code unknown to the user, such that the user has difficulty in properly solving such malfunction or fault of the home appliance. Although the user communicates with a service technician who works for the service center by phone or E-mail, the user may have difficulty in correctly explaining a faulty operation status of the home appliance to the service person, such that the service technician may also have difficulty in providing a correct solution to the user. Although the service technician visits a home of the user who has requested after-sale service, the service technician does not recognize a correct status of the home appliance to the service technician, such that the repair of the home appliance generally takes a long time and much cost. For example, if the service technician who visits the home of the user does not have an appropriate component needed to repair the home appliance, the service technician must re-visit the corresponding home later after returning to the service center to retrieve the appropriate component, resulting in the occurrence of greater inconvenience and a long repair time.

In order to solve the above-mentioned problems, the home appliance may be connected to a server of the service center through a predetermined communication unit. However, a communication network must be implemented between each home and the service center.

### SUMMARY OF THE INVENTION

Accordingly, the present invention is directed to a diagnostic system and method for a home appliance that substantially obviate one or more problems due to limitations and disadvantages of the related art.

Therefore, the present invention has been made in view of the above problems, and it is an object of the present invention to provide a system and method for diagnosing a home appliance, which allow the home appliance to output a sound signal including product information related to a home-appliance operation status, diagnose a current status and fault of the home appliance using a large amount of product information contained in the sound signal, and thus recognize a correct status of the home appliance.

In accordance with an aspect of the present invention, the above and other objects can be accomplished by the provision of a diagnostic system for a home appliance including at least one home appliance for outputting a sound signal including product information; and a diagnostic server for receiving the sound signal from the home appliance, and diagnosing a faulty operation of the home appliance. The diagnostic server detects the product information form the sound signal, and diagnoses a status of the home appliance on the basis of a plurality of data items according to a correlation between individual data items contained in the product information.

In accordance with another aspect of the present invention, there is provided a home appliance including an operating unit for receiving a signal output command; a controller for generating a digital signal of a predetermined format on the basis of product information upon receiving the signal output command, wherein the product information includes operation status data, status information and measurement data of each sensor, and fault information including an error code; a converter for converting the digital signal into a modulated signal of a predetermined frequency band; and a sound output unit for outputting the modulated signal as a sound signal.

In accordance with another aspect of the present invention, there is provided a diagnostic system for a home appliance including at least one home appliance for outputting a sound signal including product information; and a diagnostic server for receiving the sound signal from the home appliance, extracting the product information from the sound signal, and diagnosing a faulty operation of the home appliance, wherein the diagnostic server analyzes a correlation between individual data items among several data items contained in the product information, and diagnoses a faulty operation of the home appliance using at least one related data item.

In accordance with another aspect of the present invention, there is provided a diagnostic method for use in a diagnostic server, the method including extracting product information upon receiving a sound signal from a home appliance; analyzing a plurality of data items contained in the product information so as to check an error code, and thus classifying a category of a faulty operation; detecting at least one data item related to the faulty operation category in response to a value of the error code, and obtaining a diagnosis result according to a correlation between the detected data items; and outputting the diagnosis result.

As described above, the diagnostic system and method for the home appliance according to the present invention control the home appliance to output a sound signal including a large amount of product information, diagnose a current status of the home appliance by analyzing the sound signal, obtain information needed for diagnosis, and perform not only a diagnosis function but also a function for analyzing a current status and the cause of a fault, resulting in increased accuracy of diagnosis. In addition, the diagnostic system or method for the home appliance can analyze a detailed reason and solution for the faulty operation on the basis of a large amount of information, and need not perform an unnecessary checkup of the home appliance, so that after-sale service is greatly facilitated.

### BRIEF DESCRIPTION OF THE DRAWINGS

The above and other objects, features and other advantages of the present invention will be more clearly understood from the following detailed description taken in conjunction with the accompanying drawings, in which:

FIG. 1 schematically illustrates a diagnostic system including a home appliance according to one embodiment of the present invention.

FIGS. 2(a) and 2(b) illustrate a home appliance and a relationship between the home appliance and a service center according to one embodiment of the present invention.

FIG. 3(a) is a block diagram of a home appliance and FIG. 3(b) is a block diagram illustrating a diagnostic server according to one embodiment of the present invention.

FIGS. 4(a) and 4(b) illustrate exemplary structures of a sound signal that is output from a home appliance and received in a diagnostic server according to one embodiment of the present invention.

FIG. 5 is a flowchart illustrating a method for controlling the diagnostic server of FIG. 3 to diagnose a faulty water-supply operation using product information of a home appliance according to one embodiment of the present invention.

FIGS. 6 and 7 illustrate methods for controlling the diagnostic server of FIG. 3 to diagnose a faulty water-supply operation using product information of a home appliance according to another embodiment of the present invention.

FIG. 8 is a flowchart illustrating a method for controlling the diagnostic server of FIG. 3 to diagnose a faulty operation according to a supplied power using product information of a home appliance according to the present invention.

### DETAILED DESCRIPTION OF THE PREFERRED EMBODIMENTS

Now, exemplary embodiments of the present invention will be described in detail with reference to the annexed drawings.

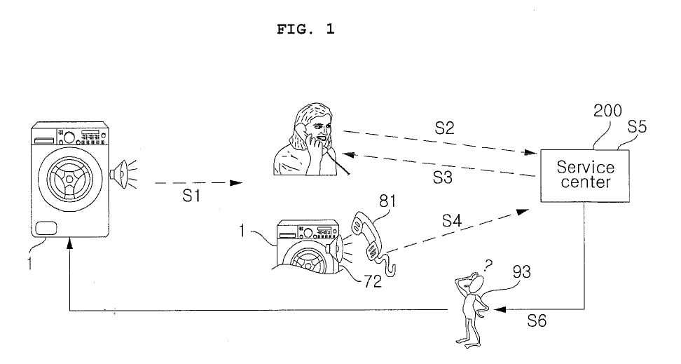

FIG. 1 schematically illustrates a diagnostic system including a home appliance according to one embodiment of the present invention.

Referring to FIG. 1, the diagnostic system according to the present invention includes a home appliance 1 separately installed at each place and a diagnostic server for diagnosing a status and fault of the home appliance. The home appliance 1 includes a display unit and a sound output unit for outputting a sound signal.

If product information or status information of the home appliance 1 is output as a sound signal through the home appliance 1 installed at each home, a sound signal including the product information and the status information is transmitted to the diagnostic server of a service center 200 through a telephone line, such that the diagnostic server can diagnose the presence or absence of a faulty operation in the home appliance 1.

A user recognizes product information of the home appliance 1 through an output unit of the home appliance 1, controls operations of the home appliance 1, or requests after-sale service from the service center 200 at step S2.

The user who has a home appliance 1 to be repaired communicates with the service center by phone, E-mail or other mode of communication, receives an instruction message from a counselor or adviser of the service center at step S3, and operates an input unit embedded in the home appliance 1, such that the home appliance 1 outputs a sound signal detailing product information at step S4, and transmits the sound signal to the service center. In this case, the home appliance 1 according to the present invention is not limited only to a specific function for outputting product information, and is extended to another function for converting the product information into a predetermined sound signal and thus outputting the resultant sound signal.

In other words, when the user establishes a call connection with an adviser of the service center 200 at steps S2 and S3, the user moves a phone 81 close to an audible part of the home appliance 1, such that a sound signal S1 including product information or status information that is output when a malfunction or fault occurs in the home appliance 1 is transferred to the service center through a telephone line at step S4.

The adviser of the service center allows the home-appliance sound signal received through the telephone line to be stored in a diagnostic server. The diagnostic server analyzes the sound signal and thus diagnoses a product status of the home appliance 1 and the presence or absence of a faulty operation in the home appliance 1 at step S5.

In response to the diagnosis result of the home appliance 1, the service center 200 sends a service technician or repairman 93 to a home of the user who requested the after-sale service, such that the service technician can provide the user with a repair service suitable for a product status or a diagnosed fault at step S6. In this case, the diagnosis result is transferred to a portable terminal of the service technician 93 such that the service technician 93 can repair a faulty operation of the home appliance 1. Otherwise, the diagnosis result may also be transferred to the user through the adviser of the service center. In addition, the diagnosis result may be transferred to the user by E-mail or may also be transferred to the portable terminal of the user.

Therefore, if the user establishes a call connection with the service center through a communication network (e.g., a telephone line), the diagnostic system correctly recognizes a current status of the home appliance 1 through the sound signal and properly copes with the recognized status, such that a necessary service can be quickly provided to the user.

Now, although the term ‘home appliance’ disclosed in the present invention is exemplarily set to a washing machine for convenience of description and better understanding of the present invention, the scope or spirit of the term ‘home appliance’ is not limited thereto, but is applicable to other home appliances, for example, a television, a refrigerator, an electric rice cooker, a microwave oven, and the like.

The home appliance 1 can be configured as follows to output product information as a predetermined sound signal, such that the diagnostic server can diagnose the status or fault of the home appliance 1 on the basis of the sound signal including the product information.

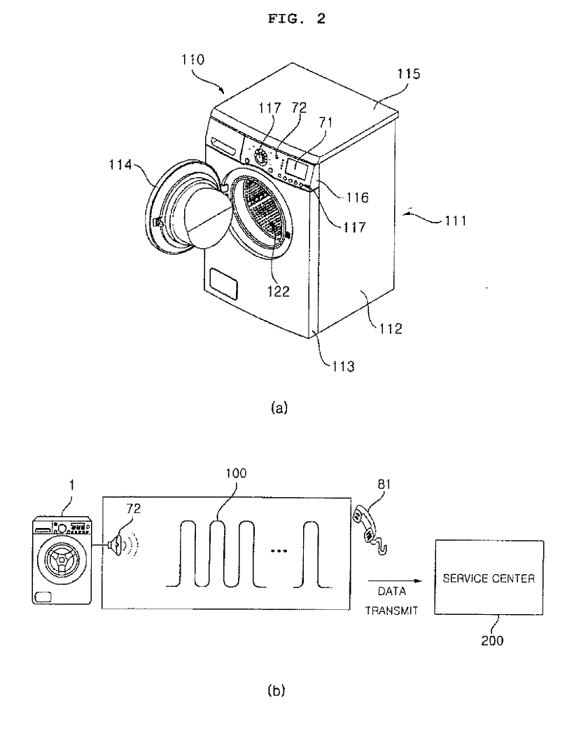

FIGS. 2(a) and 2(b) illustrate a home appliance and a relationship between the home appliance and a service center according to one embodiment of the present invention.

As one example of the home appliance, a washing machine will be described in detail. Referring to FIG. 2(a), the washing machine 1 includes a cabinet 111, a tub 122 installed in the cabinet 111 to clean laundry or clothes, a motor (not shown) for driving the tub 122, a water provider (not shown) for providing clean water to the tub 122, and a drainage unit (not shown) for draining dirty or soiled water generated during the laundry cleaning.

The cabinet 111 includes a cabinet frame 112, a cabinet cover 113 that is located at an upper part of the cabinet frame 112 and coupled to the cabinet frame 112, a control panel 116 that is located at an upper part of the cabinet cover 113 and controls operations of the washing machine, and a top plate 115 that is located at an upper part of the control panel 116 and is coupled to the cabinet frame 112. The cabinet cover 113 includes a hole (not shown) via which laundry is placed in or withdrawn from the tub 122, and a door 114 that rotates to open or close the hole.

The control panel 116 includes a plurality of operation keys or buttons 117 to control operations of the washing machine 1, a sound output unit 72 for outputting a sound signal indicating an operation status of the washing machine 1, and a display unit 71 for displaying the operation status in the form of an image.

Referring to FIG. 2(b), if a faulty operation occurs in the washing machine 1, information as to the faulty operation may be displayed on the display unit 71, or an alarm sound may be output. Therefore, if the faulty operation occurs in the washing machine 1, the user of the washing machine 1 communicates with the service center 200, receives an instruction message from an adviser of the service center, and thus properly handles or operates an operating unit 22 according to the received instruction message.

If the user presses the operating unit 22 of the washing machine 1, a signal output command is input to the washing machine 1, a digital signal including product information is generated, the digital signal is converted into a modulated signal through the converter 60, and the modulated signal is output as a predetermined sound signal through the sound output unit 72.

In this case, the sound signal 100 output from the sound output unit 72 is transferred to the service center 200 through a portable terminal 81 connected to a predetermined communication network. For example, the communication network may be a telephone network or a mobile communication network, and the portable terminal 81 may be a telephone or a mobile terminal.

The service center 200 analyzes the sound signal received from the portable terminal 81, and obtains operation information and fault information of the home appliance 1. Therefore, the service center may transmit a solution for obviating a faulty operation of the home appliance 1 to the user, or may dispatch a service technician to the user.

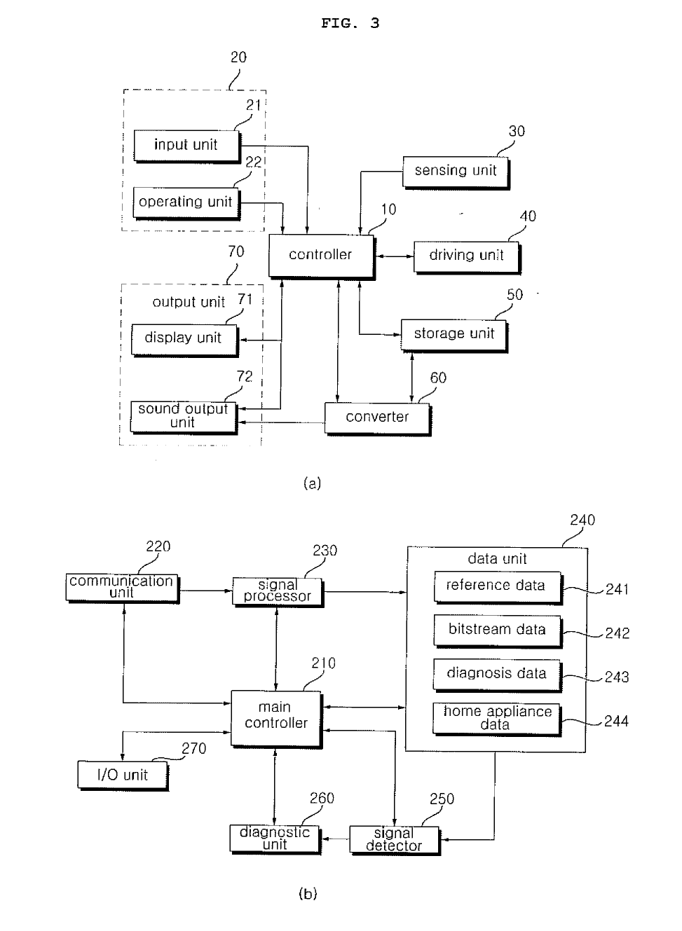

FIG. 3 illustrates a home appliance and a diagnostic server according to one embodiment of the present invention. In more detail, FIG. 3(a) is a block diagram of the home appliance 1 and FIG. 3(b) is a block diagram illustrating the diagnostic server according to one embodiment of the present invention.

The aforementioned washing machine 1 may further include the following control elements. Referring to FIG. 3(a), the washing machine 1 includes an input unit 21, an operating unit 22, a sensing unit 30, a driving unit 40, a storage unit 50, a converter 60, an output unit 70, and a controller 10 for controlling overall operations of the washing machine 1. In this case, the output unit 70 may include a display unit 71 and a sound output unit 72.

The driving unit 40 receives a control command from the controller 10, and thus performs a predetermined operation in response to the received control command. In the case of the washing machine, the driving unit 40 drives and controls a motor for rotating a washing tub or drum in such a manner that pollutants or contaminants can be separated from laundry by rotation of the tub or drum. In addition, upon receiving a control command from the controller 10, the driving unit 40 controls valves to perform a water-supply function or a drainage function.

The sensing unit 30 includes at least one sensor. When the washing machine 1 performs a predetermined action via the driving unit 40, the sensing unit 30 measures data for checking an operation status of the washing machine 1 and transmits the measured data to the controller 10. For example, the sensing unit for use in the washing machine measures a water level in a water-supply mode or a drainage mode, and measures a temperature of the supplied water and a rotation speed of the washing tub or drum.

The storage unit 50 stores operation status data generated when the washing machine 1 performs a predetermined operation, stores operation information (e.g., setup data) received from the input unit 21 to allow the washing machine 1 to perform a predetermined operation, and also stores fault information as to the cause of the fault or the faulty part when a faulty operation occurs in the washing machine 1.

In addition, the storage unit 50 stores control data for controlling operations of the washing machine 1 and reference data used for operation control. The storage unit 50 may further store status information of each sensor contained in the sensing unit 30 and measurement data of each sensor.

The operating unit 22 includes at least one input unit, receives a signal output command for controlling product information to be generated as a predetermined sound signal through the sound output unit 72, and outputs the signal output command to the controller 10. The operating unit 22 receives the signal output command so that it controls the sound output unit 72 to be switched on or off in response to the signal output command. In other words, upon receiving the signal output command from the operating unit 22, the washing machine outputs a predetermined sound signal indicating product information in response to a digital signal generated from the controller 10. In this case, the sound output unit 72 may be used to output the predetermined sound signal.

The input unit 21 may receive setup information related to the output of such a sound signal. In more detail, the input unit 21 may receive a variety of setup values as to a method for generating a sound signal, a volume of the generated sound signal, etc.

The user input part 20 such as the operating unit 22 or the input unit 21 may be configured to include buttons, a dome switch, a touch pad (including a static-pressure type and an electrostatic type), a jog wheel, a jog switch, a finger mouse, a rotary switch, a jog dial, or the like. Any device is applicable as the input portion 20 so long as it generates predetermined input data by manipulation such as pressure, rotation, contact, etc.

The controller 10 receives a signal output command from the operating unit 22, generates a digital signal including product information by retrieving product information stored in the storage unit 50, applies the generated digital signal to the converter 60, and converts the digital signal including product information into a specific modulated signal. Upon receiving the signal output command from the operating unit 22, the controller 10 controls the sound output unit 72 to be operated.

The controller 10 includes operation status data, operation information, and fault information stored in the storage unit 50 in product information, further includes status information and measurement data of each sensor contained in the sensing unit 30 in such product information, and outputs the resultant product information as a sound signal.

In this case, the product information may include operation information and fault operation, wherein the operation information includes information as to an operation setup and information as to an operation status, and the fault operation includes information as to a malfunction or faulty operation. The product information may be data composed of a combination of 0s and 1s, and may be a digital signal readable by the controller 10.

The converter 60 converts a digital signal including product information into a modulated signal for outputting a sound signal. In this case, the converter 60 converts the product information denoted by a digital signal into an analog signal having a predetermined frequency band. During the signal conversion, the converter 60 converts a digital signal into a modulated signal using any one of a frequency shift keying (FSK) scheme, an amplitude shift keying (ASK) scheme, and a phase shift keying (PSK) scheme.

In this case, the frequency shift keying scheme converts an input signal into a predetermined-frequency signal in response to a data value of product information. The amplitude shift keying scheme converts an input signal into another signal that has different amplitudes according to data values. The phase shift keying scheme converts an input signal into another signal that has different phases according to data values of product information.

The converter 60 converts a digital signal including product information into a signal of a predetermined frequency band according to the above-mentioned scheme, combines individual modulated signals with each other, and outputs the combined modulation signal.

In this case, the generated sound signal may include product information and a preamble indicating the beginning of data including the product information in a header part of data, and this data includes not only product information but also a check bit for detecting errors in data.

The sound output unit 72 is switched on or off under the control of the controller 10, receives a modulated signal from the converter 60, and thus outputs a predetermined sound signal. For example, the sound output unit 72 may be a speaker or a buzzer to output the sound signal.

The sound output unit 72 outputs a modulated signal as a sound signal. If the output of the sound-signal is completed, the sound output unit 72 stops operation. If a signal output command is input to the sound output unit 72 through the operating unit 22, the sound output unit 72 is re-operated so that it outputs a predetermined modulated signal.

In response to a control signal of the controller 10, the display unit 71 displays input information entered by the operating unit 22 and the input unit 21, information as to an operation status of the washing machine 1, and information as to the completion of a home-appliance operation on the screen. In addition, the display unit 71 displays information as to a faulty operation of the home appliance on the screen.

In this case, the output unit 70 may further include the sound output unit 72, the display unit 71, a lamp being switched on or off, a vibration element, and the like, and a detailed description thereof will be omitted herein.

The above-mentioned washing machine 1 outputs a predetermined sound signal, such that it can transmit product information of the washing machine 1 to the service center 200 according to the following description.

If product information of the washing machine 1 is output as a sound signal and is transmitted to the service enter 200 through a telephone network, the product information is input to the diagnostic server of the service center 200 such that the diagnostic server can diagnose a faulty operation of the washing machine 1.

Referring to FIG. 3(b), the diagnostic server may include a communication unit 220, a signal processor 230, a data unit 240, an input/output (I/O) unit 270, a signal detector 250, a diagnostic unit 260, and a main controller 210 for controlling overall operations of the diagnostic server.

The I/O unit 270 may include an input unit pressed by a user of the service center 200, for example, buttons, keys, a touch pad, a switch, etc. The I/O unit 270 may further include a display unit for outputting not only operation information of the diagnostic server but also the diagnosis result. The I/O unit 270 may include an external input device and an interface for accessing a portable memory unit.

If the input unit is pressed or manipulated, the I/O unit 270 transmits a signal to the main controller 210, and allows a sound signal of the washing machine to be transferred from a telephone or portable terminal of a user who connects to a telephone network to the diagnostic server.

The communication unit 220 is connected to a network of the service center so that it transmits and receives data to and from the service center over the network. The communication unit 220 is connected to an external network such as the Internet so that it communicates with the external network. Specifically, if a record command or a reception command is input to the communication unit 220 through the input unit according to a control command of the main controller 210, the communication unit 200 receives a sound signal and transmits the diagnosis result to an external part through a telephone network.

The data unit 240 includes bitstream data 242, reference data 241, and diagnosis data 243. The bitstream data 242 includes control data for operating the diagnostic server and sound data received from the home appliance such as the washing machine. The reference data 241 detects product information of a home appliance from the sound data. The diagnosis data 243 is used to diagnose the presence or absence of a fault and the cause of the fault. The data unit 240 may further include home appliance data 244 indicating the product information of the home appliance 1 detected from the bitstream data 242.

In this case, the data unit 240 receives the reference data 241, the bitstream data 242, the diagnostic data 243, and the home appliance data 244 from the main controller 210, and manages and updates the received data 241 to 244.

The signal processor 230 converts analog data indicating the received sound signal into other data, and stores the converted data as the bitstream data 242. In this case, the signal conversion performed by the signal processor 230 may be identical to inverse conversion of a previous signal conversion performed by the home appliance 1. Preferably, a mutual agreement is provided between each home appliance and the diagnostic server, so that each home appliance and the diagnostic server may perform data conversion using the same signal conversion system. The signal processor 230 may convert an analog signal (i.e., a sound signal) of a predetermined frequency band into a digital signal through inverse conversion based on any one of a frequency shift keying scheme, an amplitude shift keying scheme, and a phase shift keying scheme.

The signal detector 250 firstly detects a preamble indicating the beginning of data from the bitstream converted by the signal processor 230, detects data including product information on the basis of the detected preamble, and transmits the detected data as the home appliance data 244 in the data unit 240.

The signal detector 250 detects a preamble and data on the basis of a preamble size and a data size contained in the reference data 241, and stores the detected preamble and data as home appliance data 244 in the data unit 240.

The diagnostic unit 260 analyzes data detected by the signal detector 250, determines a current status and fault of the home appliance 1 using product information contained in the analyzed data, analyzes the cause of fault, and finally outputs the diagnosis result.

Since a large amount of product information is contained in the sound signal generated from the home appliance 1, the diagnostic unit 260 analyzes each data item contained in the product information, and diagnoses the home appliance according to a correlation between individual data items. In this case, the diagnostic unit 260 diagnoses a current status of the home appliance using not only a diagnosis algorithm contained in the diagnosis data 243 but also a reference value required for diagnosis.

The main controller 210 controls transmission and reception of data through the communication unit 220, controls the flow of data through the I/O unit 270, converts the sound signal including product information of the home appliance into other data through the signal processor 230, and controls the signal detector 250 to detect the converted resultant data.

The main controller 210 transmits a control command to each part in such a manner that the diagnostic unit 260 diagnoses a faulty operation of the home appliance using the detected data. The main controller 210 may output a diagnosis result of the diagnostic unit 260 through the I/O unit 270, or may control the diagnosis result to be transmitted through the communication unit 220.

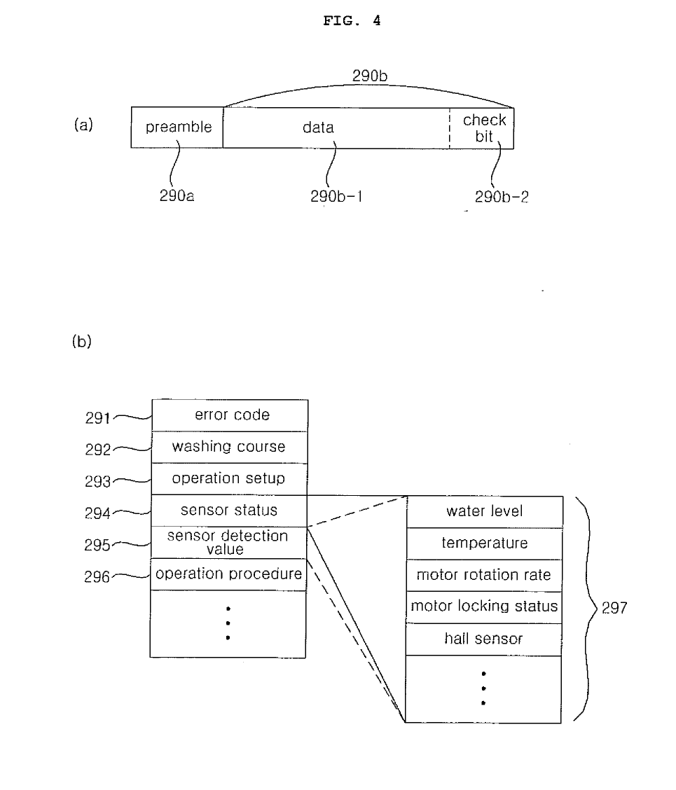

FIGS. 4(a) and 4(b) illustrate exemplary structures of a sound signal that is output from a home appliance and received in a diagnostic server according to one embodiment of the present invention.

Referring to FIGS. 4(a) and 4(b), the home appliance 1 outputs a sound signal. The sound signal includes data including product information and a preamble for detecting data, a digital signal is formed of the resultant sound signal, and the digital signal is output as a sound signal through the sound output unit 72.

Referring to FIG. 4(a), data 290 comprised of the sound signal generated from the home appliance includes a preamble 290a and data 290b. The data 290b includes product information 290b-1 and a check bit 290b-2. The diagnostic server receives the sound signal.

While the output time of the sound signal is being output, the controller 10 of the home appliance stores fault information and information of overall home-appliance operations in the product information. For example, operation status data stored in the storage unit 50, operation information, fault information, status information of each sensor of the sensing unit 30, and measurement data of each sensor may be included in the product information. The product information includes a preamble and forms a digital signal using the preamble. The product information is converted into a modulated signal through signal conversion of the converter, and the modulated signal is output as a sound signal.

The diagnostic server receives the sound signal, detects a preamble, detects data on the basis of a preamble, analyzes home-appliance product information contained in the detected data, and diagnoses a malfunction or fault of the home appliance.

Referring to FIG. 4(b), the product information contained in the data 290b includes a plurality of data items, and data being output as a sound signal includes a large amount of product information.

For example, product information of the data that is transmitted as the sound signal may include at least one of a data item of an error code 291 indicating faulty operations of a washing machine; a data item of a washing course 292 related to an operation that was performed or is currently performed; a data item of an operation setup 293 related to an operation of the washing machine; a data item of a sensor status 294 indicating whether a sensor of the sensing unit 30 is normally operated; a data item of a sensor detection value 295 measured by each sensor of the sensing unit 30; and a data item of an operation procedure 296 that is currently performed.

Specifically, the sensor status 294 and the sensor detection value 295 include a status and a detection value of each sensor contained in the sensing unit 30. For example, the sensor status 294 and the sensor detection value 295 may include sensor information 297, for example, a water level, a temperature, a rotation rate of a motor, a motor locking status, sensing information of a hall sensor, etc.

The above-mentioned data items have been disclosed only for illustrative purposes, the scope and spirit of such items are not limited thereto, but applicable to all kinds of data items related to home appliance operations. The data items may be contained in product information so as to be output as a sound signal.

Operations of the above-mentioned diagnostic system for the home appliance will hereinafter be described in detail. Herein, although the term ‘home appliance’ disclosed in the present invention is exemplarily set to a washing machine for convenience of description and better understanding of the present invention, the scope or spirit of the term ‘home appliance’ is not limited thereto, but is applicable to other home appliances.

The sound signal generated from the above-mentioned home appliance may be transferred to the diagnostic server of the service center over a general telephone network or a mobile communication network. The diagnostic server detects data from the received sound signal, diagnoses a current status of the home appliance, a faulty operation, and the cause of the faulty operation on the basis of a large amount of product information contained in the detected data, and transmits the diagnosis result to the user of the home appliance. The user of the home appliance receives the diagnosis result, repairs a faulty operation of the home appliance according to the diagnosis result or calls a service technician from the service center to repair the faulty operation. The service technician who visits a home of the user can repair the faulty operation of the home appliance by referring to the diagnosis result.

In this case, an exemplary method for allowing the diagnostic server to diagnose a current status and faulty operation of the home appliance using the product information contained in the sound signal will hereinafter be described in detail.

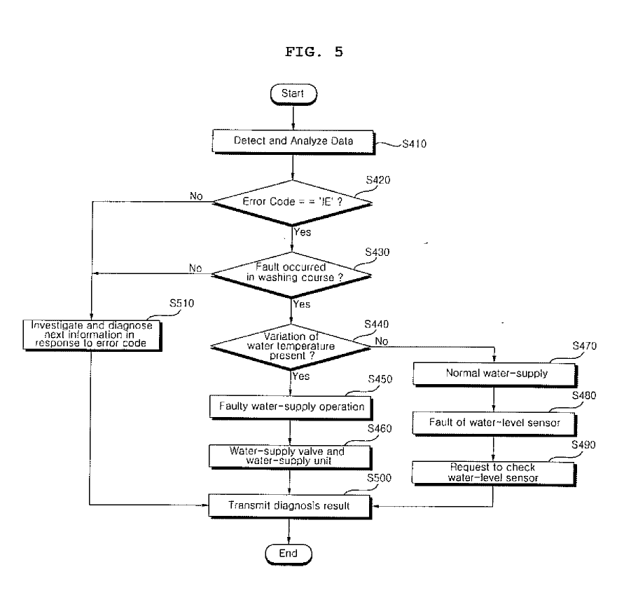

FIG. 5 is a flowchart illustrating a method for controlling the diagnostic server of FIG. 3 to diagnose a faulty water-supply operation using product information of a home appliance according to one embodiment of the present invention.

Referring to FIG. 5, the diagnostic server controls the converter 220 to convert sound data into other data, controls the signal detector 250 to detect data from the sound data, and controls the diagnostic unit 260 to analyze the detected data and diagnose a current status or fault of the home appliance using product information contained in the data at step S410.

The diagnostic unit 260 firstly checks the error code 291 from among a plurality of data items contained in the product information. If the error code is set to ‘IE’, this error code ‘IE’ means that a malfunction or faulty operation occurs in a water-supply mode, searches for data items related to the water-supply mode, and checks a value of each searched data item at step S420.

The diagnostic unit 260 determines whether or not a faulty operation occurs in the washing course using a plurality of data items at step S430. If the faulty operation occurs in the washing course, the diagnostic unit 260 checks a data item related to water temperature.

The diagnostic unit 260 detects a variation of water temperature by determining whether a water temperature is increased or reduced at step S440. If the diagnostic unit 260 detects variation of the water temperature, it determines the occurrence of a faulty water-supply operation at step S450.

In this case, the diagnostic unit 260 checks not only a data item regarding the sensor detection value 295 but also a data item regarding the sensor status 294, such that it determines whether a wrong or faulty temperature has been recorded because of a fault of a temperature sensor for detecting the water temperature.

The diagnostic unit 260 may output a command signal to check a faulty water-supply operation or a faulty operation of a water-supply valve or water-supply unit, such that it generates a diagnosis result at step S460. The main controller 210 may output the diagnosis result through the I/O unit 270, or may output the diagnostic result to a portable terminal of the service technician. In the meantime, if there is no variation in water temperature even though the error code 291 is set to ‘IE’ and a faulty operation occurs in the washing course, the diagnostic unit 260 determines whether a water-supply status is normal at step S470, and determines a faulty operation of either the water-level sensor or the water-temperature sensor using a data item of the sensor status 294 at step S480.

The diagnostic unit 260 diagnoses faulty operation of the water sensor or the water-temperature sensor, generates a diagnosis result for commanding (or requesting) a user to check a corresponding sensor at step S490, and transmits the generated diagnosis result to the main controller 210. Accordingly, the main controller 210 may transmit the diagnosis result to the user or the service technician at step S500.

In this case, if the error code 291 has a different value or is generated from procedures other than the washing course, the diagnostic unit 260 checks related items among a plurality of data items in response to the corresponding error code, and investigates and diagnoses information related to the checked items at step S510.

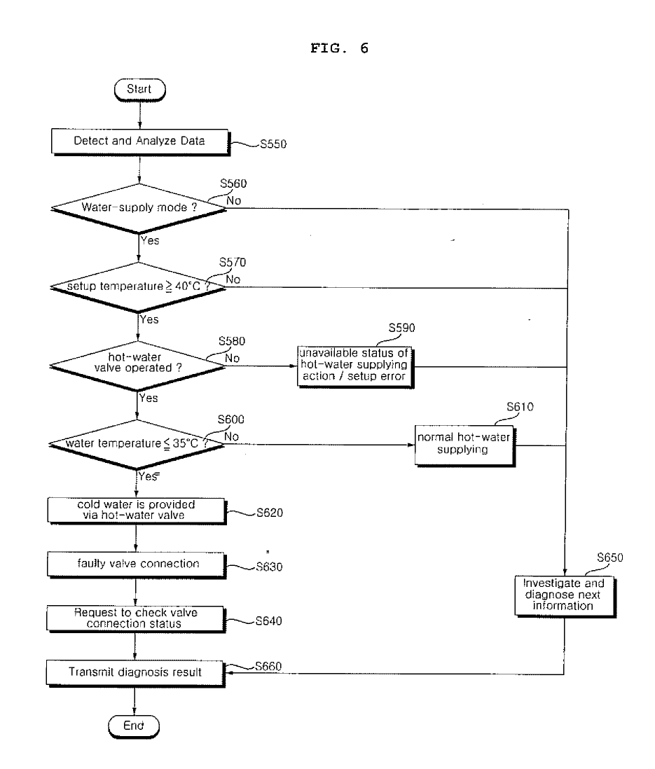

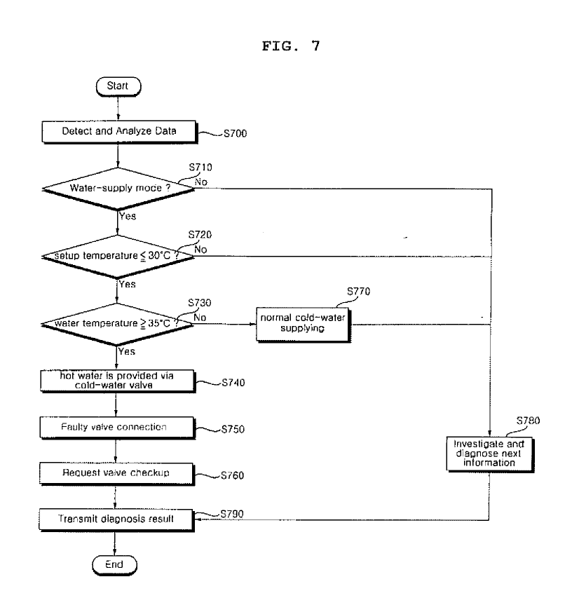

FIGS. 6 and 7 illustrate methods for controlling the diagnostic server of FIG. 3 to diagnose a faulty water-supply operation using product information of a home appliance according to another embodiment of the present invention.

Referring to FIG. 6, the diagnostic server controls the converter 220 to convert sound data into other data, controls the signal detector 250 to detect data from the sound data, and controls the diagnostic unit 260 to analyze the detected data and diagnose a current status or fault of the home appliance using product information contained in the detected data at step S550.

In this case, the diagnostic unit 260 determines whether the detected faulty operation is indicative of a faulty water-supply operation generated in the water-supply mode on the basis of information of the washing course 292 and information of the operation procedure 296 among several data items of the product information at step S560. If it is determined that the detected faulty operation is the faulty water-supply operation, the diagnostic unit 260 determines whether a setup temperature is 40° C. or more in response to the data item of the operation setup 293 at step S570.

In this case, if the detected faulty operation is not identical to a faulty water-supply operation generated in the water-supply mode or if a setup temperature is lower than 40° C., the diagnostic unit 260 further investigates the following information and thus provides the diagnosis result in which the investigation result is reflected at step S650.

If the setup temperature is equal to or higher than 40° C., the diagnostic unit 260 determines whether a hot-water valve is in a water-supply enable status at step S580. If the hot-water valve is incapable of providing hot water to the washing machine, the diagnostic unit 260 determines that the hot-water valve is not connected to a hot-water faucet, such that it determines an unavailable status of the hot-water supplying action and a setup error at step S590. In other words, since it is impossible for the washing machine to receive the hot water and water temperature is set to 40° C. or more, the diagnostic unit 260 determines the occurrence of a setup error, further investigates the next information, and thus diagnoses a current status of the washing machine according to the investigated result at step S650.

On the other hand, if the hot-water valve is capable of providing hot water to the washing machine, the diagnostic unit 260 determines whether or not water temperature is set to 35° C. or less through the sensor detection value 215 from among data items at step S600.

If it is assumed that a faulty operation occurs in the water-supply mode, the setup temperature is set to 40° C. or more, and the water temperature detected when the washing machine is connected to the hot-water valve is set to 35° C. or less, the diagnostic unit 260 determines that cold water is provided via the hot-water valve at step S620, diagnoses a faulty valve connection at step S630, and thus generates a diagnostic result that commands or requests the user to check a valve connection status at step S640.

On the other hand, if it is assumed that a faulty operation occurs in the water-supply mode, the setup temperature is set to 40° C. or more, and the water temperature detected when the washing machine is connected to the hot-water valve is set to 35° C. or more, the diagnostic unit 260 determines that hot water is normally provided via the hot-water valve at step S610, further investigates the next information, and thus diagnoses a current status of the washing machine according to the investigated result at step S650.

If the diagnosis is completed and the diagnosis result is generated, the main controller 210 transmits the diagnosis result as described above at step S660.

Examples of other faulty operations in the water-supply mode are shown in FIG. 7.

Referring to FIG. 7, the diagnostic unit 260 receives data detected by the signal detector 250, analyzes the received data, and diagnoses a faulty operation of the washing machine at step S700.

The diagnostic unit 260 determines whether a faulty operation occurs in a water-supply mode from among several operation modes of the washing machine at step S710. If the faulty operation relates to the water-supply mode, the diagnostic unit 260 determines whether a setup temperature is 30° C. or less at step S720.

In this case, the diagnostic unit 260 determines whether the detected faulty operation is identical to a faulty water-supply operation generated in the water-supply mode on the basis of the washing course item 292 and the operation procedure item 296 among several data items of the product information. The diagnostic unit 260 checks a setup temperature on the basis of the operation setup item 293 from among data items.

In this case, if the detected faulty operation is not identical to the faulty water-supply operation generated in the water-supply mode or if a setup temperature is lower than 30° C., the diagnostic unit 260 further investigates the following information and thus provides the diagnosis result in which the investigation result is reflected at step S780.

If the setup temperature is 30° C. or less, the diagnostic unit 260 determines whether the water temperature is 35° C. or more on the basis of the sensor detection value 295 among data items at step S730.

In the case where the faulty operation occurs in the water-supply mode, the setup temperature is 30° C. or less, and the water temperature is 35° C. or more, the diagnostic unit 260 determines that hot water is provided via the cold-water valve at step S740, diagnoses the occurrence of a faulty operation caused by a faulty valve connection at step S750, and thus generates a diagnostic result that commands or requests the user to check a valve connection status at step S760.

On the other hand, if it is assumed that a faulty operation occurs in the water-supply mode, the setup temperature is set to 30° C. or less, and the water temperature is lower than 35° C., the diagnostic unit 260 determines that cold water is normally provided via the cold-water valve at step S770, further investigates the next information, and thus diagnoses a current status of the washing machine according to the investigated result at step S780.

If the diagnosis is completed and the diagnosis result is generated, the main controller 210 transmits the diagnosis result as described above at step S790.

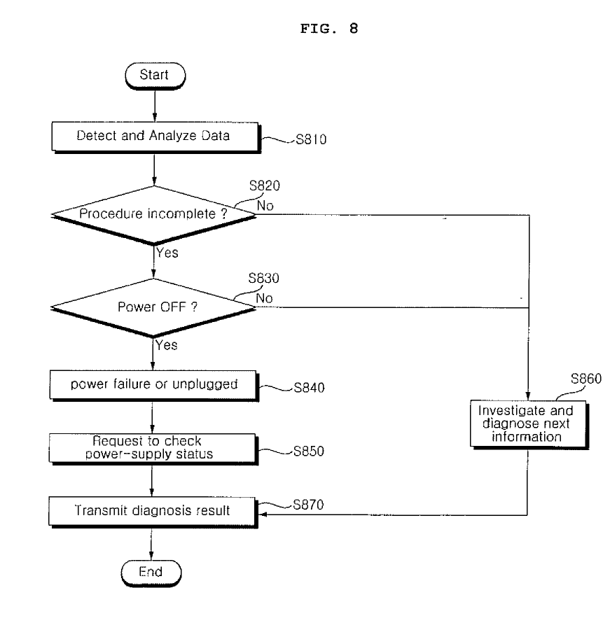

FIG. 8 is a flowchart illustrating a method for controlling the diagnostic server of FIG. 3 to diagnose a faulty operation according to a supplied power using product information of a home appliance according to the present invention.

Referring to FIG. 8, the diagnostic unit 260 analyzes input data on the basis of data detected by the signal detector 250, confirms a large amount of product information, and diagnoses a faulty operation of the home appliance on the basis of the confirmed product information at step S810.

The diagnostic unit 260 determines whether the operation procedure is not yet completed on the basis of the washing course 292, the operation procedure 296, and the operation setup 293 from among several data items of the product information at step S820.

The diagnostic unit 260 determines whether the washing machine is powered off at step S830. If it is determined that the washing machine is powered off at step S830, the diagnostic unit 260 determines that the power supply has been interrupted due to power failure or unplugging so that the operation procedure is not completed at step S840.

Accordingly, the diagnostic unit 260 generates the diagnosis result that commands or requests the user to check a power-supply status of the washing machine at step S850.

In this case, if the operation procedure is completed, or if the washing machine is not yet powered off even though the operation procedure is not completed, the diagnostic unit 260 further investigates the following information and thus provides the diagnosis result in which the investigation result is reflected at step S860.

If the diagnosis is completed and the diagnosis result is generated, the main controller 210 transmits the diagnosis result as described above at step S870.

Although the present invention has disclosed five embodiments, each of which diagnoses a current status of the home appliance using product information contained in the sound signal, the five embodiments are disclosed only for illustrative purposes, the scope and spirit of the present invention are not limited thereto, and the present invention can obtain a variety of diagnosis results using data items of the product information.

As is apparent from the above description, under the condition that the product information including either information of a fault of the home appliance or operation information (such as setup information) for operating the home appliance is converted into a predetermined sound signal and the predetermined sound signal is then output, the diagnostic system or method for the home appliance according to the present invention controls the home appliance to output a large amount of product information, and diagnoses a faulty operation of the home appliance using the product information, such that the diagnosis is facilitated due to the large number of basis materials needed for such diagnosis and it is possible for the diagnostic system to obtain a detailed diagnosis result of the home appliance.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A home appliance comprising:
an operating unit for receiving a signal output command;
a controller for generating a digital signal of a predetermined format on the basis of product information upon receiving the signal output command, wherein the product information includes operation status data, status information and measurement data of each sensor, and fault information including an error code;
a converter for converting the digital signal into a modulated signal of a predetermined frequency band; and
a sound output unit for outputting the modulated signal as a sound signal.

2. The home appliance according to claim 1, wherein the controller configures the product information, in which
the product information includes at least one of a data item of an error code indicating a faulty operation of the home appliance, a data item of status information as to an operation that was performed or is currently performed, a data item of an operation setup related to an operation, a data item of a sensor status indicating whether a sensor is normally operated, a data item of a sensor detection value measured by each sensor, and a data item of an operation procedure that is currently performed.

3. A diagnostic system for a home appliance comprising:
at least one home appliance for outputting a sound signal including product information; and
a diagnostic server for receiving the sound signal from the home appliance, extracting the product information from the sound signal, and diagnosing a faulty operation of the home appliance,
wherein the diagnostic server classifies faulty operation type according to values of fault information contained in the product information, extracts and analyzes at least one data item related to the faulty operation type, and diagnoses a faulty operation of the home appliance using at least one related data item.

4. The diagnostic system according to claim 1, wherein the diagnostic server includes:
a signal processor for inversely converting the sound signal into a digital signal;
a signal detector for extracting the product information from the conversion result of the signal processor;
a diagnostic unit for analyzing the product information using a diagnosis program and diagnosis data, and diagnosing a faulty operation of the home appliance according to a correlation between a plurality of data items contained in the product information; and
a main controller for outputting a diagnosis result of the diagnostic unit, and transmitting the diagnosis result to an external part.

5. The diagnostic system according to claim 4, wherein the diagnostic unit recognizes an error code from among the fault information, and classifies categories of faulty operations according to values of the error code.

6. The diagnostic system according to claim 5, wherein the diagnostic unit extracts and analyzes at least one data item related to the faulty operation type according to the error code value, and diagnoses a faulty operation according to a correlation between values of one or more data items.

7. A diagnostic method for use in a diagnostic server, the method comprising:
extracting product information upon receiving a sound signal from a home appliance;
analyzing a plurality of data items contained in the product information so as to check an error code, and thus classifying a category of a faulty operation;
detecting at least one data item related to the faulty operation category in response to a value of the error code, and obtaining a diagnosis result according to a correlation between the detected data items; and
outputting the diagnosis result.

8. The diagnostic method according to claim 7, wherein the obtaining of the diagnosis result includes:
recognizing status information indicating an operation process having a fault, recognizing the error code and a sensor measurement value measured in the operation process, determining whether or not the sensor has a fault, and comparing the determined result with diagnosis data, thereby diagnosing a faulty operation.

9. The diagnostic method according to claim 7, wherein the obtaining of the diagnosis result includes:
analyzing a cause of a fault of the home appliance, and outputting at least one solution for the cause as a diagnosis result, wherein the cause relates to an internal fault of the home appliance, a sensor fault, a poor connection, incorrect user manipulation, etc.

10. The diagnostic method according to claim 7, wherein the obtaining of the diagnosis result includes:
if a fault of the home appliance occurs in a water-supply mode, detecting a data item related to the water-supply mode from among the product information, analyzing the detected data item, and obtaining a cause of the fault generated in the water-supply mode and a solution for the fault cause.

11. The diagnostic method according to claim 10, wherein:
if the fault of the home appliance occurs in the water-supply mode,
in each of executed operation procedures, determining whether a water-supply action is performed on the basis of a sensor measurement value and a variation of water temperature, determining whether a category of supplied water is changed in response to a measured temperature, diagnosing a faulty connection of a water-supply valve, incorrect manipulation of a user who selects a cold water or a hot water in a water-type setup process, an unavailable water-supply status, etc. and outputting a checkup item related to each diagnosed result as a solution for solving each fault.

12. The diagnostic method according to claim 7 wherein the obtaining of the diagnosis result includes:
if the fault of the home appliance relates to a power-supply status,
determining whether the home appliance stops operation on the basis of status information, diagnosing the fault caused by a wrong power-supply operation caused by a power failure or unplugging, and outputting a diagnosis result to check a power-supply status according to the diagnosed fault.
